(19) United States
(12) Patent Application Publication
(10) Pub. No.: US 2026/0036680 A1
(43) Pub. Date: Feb. 5, 2026

(54) Variable Scan Parameter Based Laser Sensor System

(71) Applicant: The Boeing Company, Arlington, VA (US)

(72) Inventor: Nathan D. Hiller, Irvine, CA (US)

(21) Appl. No.: 18/791,594

(22) Filed: Aug. 1, 2024

(51) Int. Cl. G01S 7/481; G01S 17/933; G01S 17/95

(52) U.S. Cl. CPC G01S 7/4817; G01S 7/4814; G01S 17/933; G01S 17/95

(57) ABSTRACT

A laser beam sensor system comprising a lidar system in an aircraft and a controller. The lidar system is configured to emit a laser beam into an atmosphere during flight of the aircraft. The lidar system is configured to receive backscatter light generated in response to emitting the laser beam. The lidar system is configured to generate backscatter data using the backscatter light. The controller is configured to control the lidar system to move the laser beam to scan an area using a path from a central location to an outer location of the area. The controller is configured to adjust a number of scan parameters during scanning the area using the path. The controller is configured to generate measurements of the area using the backscatter data generated from scanning the area.

### CROSS-REFERENCE TO RELATED APPLICATIONS

This application is related to the following U.S. Patent Application entitled “Changing Laser Scan for Satellite Acquisition,” Serial No.______, attorney docket no. 23-1186-US-NP, and U.S. Patent Application entitled “Nonuniform Laser Beam Scan Based Flight Path Clearing System,” Serial No.______, attorney docket no. 23-1186-US-NP [3], filed even date hereof, assigned to the same assignee, and incorporated herein by reference in its entirety.

### STATEMENT OF GOVERNMENT INTEREST

This invention was made with United States Government support. The United States Government has certain rights in the invention.

### BACKGROUND INFORMATION

### 1. Field

The present disclosure relates generally to aircraft and in particular, to making measurements using a laser sensor system.

### 2. Background

Laser-based sensor systems can replace many vital aircraft instruments and add new capabilities for aircraft. For example, a light detection and ranging (lidar) sensor can be used to measure various parameters during the flight of an aircraft. With a lidar sensor, a laser beam is emitted into the air. The laser beam encounters aerosols in the air that reflect or “backscatter” light towards the aircraft. Aerosols are fine solid particles, liquid particles, or both, suspended in air or other gases. The backscatter of the laser beam can also be caused by the molecules in the air or objects in the air.

The backscatter light generated in response to emitting the laser beam is detected. The backscatter light can be used to generate backscatter data that is analyzed to make measurements of one or more parameters. These parameters can include the speed of the aircraft, turbulence, air temperature, and other parameters.

### SUMMARY

An embodiment of the present disclosure provides a laser beam sensor system comprising a lidar system in an aircraft and a controller. The lidar system is configured to emit a laser beam into an atmosphere during flight of the aircraft. The lidar system is configured to receive backscatter light generated in response to emitting the laser beam. The lidar system is configured to generate backscatter data using the backscatter light. The controller is configured to control the lidar system to move the laser beam to scan an area using a path from a central location to an outer location of the area. The controller is configured to adjust a number of scan parameters during scanning the area using the path. The controller is configured to generate measurements of the area using the backscatter data generated from scanning the area.

An embodiment of the present disclosure provides a method for making measurements with a laser beam. The laser beam being emitted into an atmosphere during a flight of an aircraft is moved to scan an area using a path from a central location to an outer location of the area. A number of scan parameters is adjusted during scanning the area using the path. Backscatter light generated in response to the laser beam being emitted and moved to scan the area is detected. Measurements of the area are generated using backscatter light generated from scanning the area.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in a turbulent environment in accordance with an illustrative embodiment;

FIG. 2 is an illustration of a block diagram of a measurement environment in accordance with an illustrative embodiment;

FIG. 3 is an illustration of a continuous spiral scan system in accordance with an illustrative embodiment;

FIG. 4 is an illustration of scan speed for a spiral scan in accordance with an illustrative embodiment;

FIG. 5 is an illustration of an overlap in accordance with an illustrative embodiment;

FIG. 6 is an illustration of an overlap for a spiral scan in accordance with an illustrative embodiment;

FIG. 7 is an illustration of an overlap based on jumper distribution in accordance with an illustrative embodiment;

FIG. 8 is an illustration of an overlap based on jumper distribution in accordance with an illustrative embodiment;

FIG. 9 is an illustration of a flowchart of a process for making measurements with a laser beam in accordance with an illustrative embodiment;

FIG. 10 is an illustration of a flowchart of a process for performing actions using the measurements in accordance with an illustrative embodiment;

FIG. 11 is an illustration of a flowchart of a process for making measurements for a volume in accordance with an illustrative embodiment;

FIG. 12 is an illustration of a flowchart of a process for moving a laser beam in accordance with an illustrative embodiment;

FIG. 13 is an illustration of a flowchart of a process for adjusting a number of scan parameters in accordance with an illustrative embodiment;

FIG. 14 is an illustration of a flowchart of a process for adjusting a number of scan parameters in accordance with an illustrative embodiment;

FIG. 15 is an illustration of a flowchart of a process for adjusting a number of scan parameters in accordance with an illustrative embodiment; and

FIG. 16 is an illustration of a block diagram of a data processing system in accordance with an illustrative embodiment.

### DETAILED DESCRIPTION

The illustrative embodiments recognize and take into account one or more different considerations as described herein. For example, it is desirable t direct a laser beam from a lidar system to obtain backscatter data for making measurements in different locations as quickly as possible. The faster at which measurements for detecting turbulence or windshear ahead of the aircraft are provided, more time is present to make changes in flight or make preparations for encountering turbulence or windshear.

In the illustrative example, a lidar system can be controlled to move a laser beam to different locations in an area ahead of the aircraft. Measurements may be made at these different locations. The measurements in these different locations can provide a picture of the environment ahead of the aircraft. For example, these measurements can provide an ability to visualize turbulence that may be ahead of the aircraft within the area ahead of the aircraft. The measurements can be displayed to the pilot of the aircraft.

In the illustrative examples, the laser beam can be moved from one in an area to another location in an area to perform a scan of the area. This scanning can provide measurements for the different locations in the area. These measurements can be, for example, turbulence, windshear, temperature, pressure, objects, and other types of measurements.

Increasing the speed at which the scan can be performed can increase the ability to make measurements to detect objects that may be located in one or more locations in the area being scanned. For example, measurements may identify a location of objects such as a flock of birds, insects, or other objects. Being able to identify these objects quickly can provide the pilot with more time to take action.

Thus, the illustrative examples provide a method, apparatus, system, and computer program product for making measurements with the laser beam. In one illustrative example, a laser beam sensor system comprises a lidar system in an aircraft and a controller. The lidar system is configured to emit a laser beam into an atmosphere during flight of the aircraft. The lidar system is configured to receive backscatter light generated in response to emitting the laser beam. The lidar system is configured to generate backscatter data using the backscatter light. The controller is configured to control the lidar system to move the laser beam to scan an area using a path from a central location to an outer location of the area. The controller is configured to adjust a number of scan parameters during scanning the area using the path. The controller is configured to generate measurements of the area using the backscatter data generated from scanning the area.

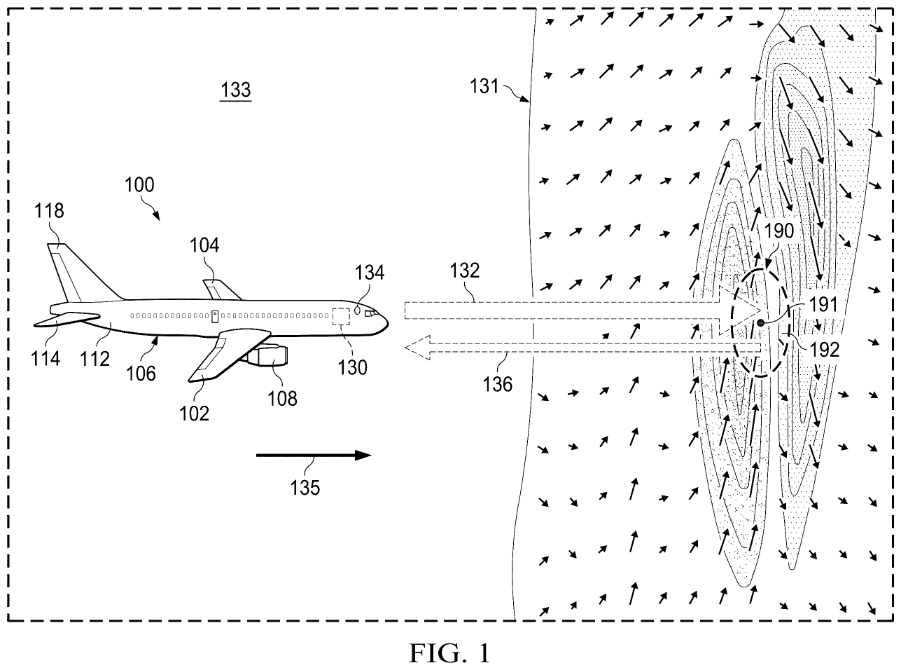

With reference now to the figures and, in particular, with reference to FIG. 1, an illustration of an aircraft in a turbulent environment is depicted in accordance with an illustrative embodiment. In this illustrative example, commercial airplane 100 has wing 102 and wing 104 attached to body 106. In some examples, body 106 can also be referred to as the fuselage. Engine 108 is attached to wing 102. In this view of commercial airplane 100, another engine is attached to wing 104 but not seen in this view.

Body 106 has tail section 112. Horizontal stabilizer 114 and vertical stabilizer 118 are attached to tail section 112 of body 106. Another horizontal stabilizer is present but not shown in this view.

Commercial airplane 100 is an example of an air vehicle in which laser beam sensor system 130 can be implemented in accordance with an illustrative example. In this illustrative example, laser beam sensor system 130 scans the environment around commercial airplane 100 to make measurements of the environment around commercial airplane 100. For example, these measurements may include measurements that detect the presence of clear air turbulence 131, which cannot be seen by the pilot of commercial airplane 100.

Further, with these measurements, the pilot or an aircraft management system can operate commercial airplane 100 to at least one of reduce the effects of clear air turbulence 131 or increase the engine performance of commercial airplane 100 to increase fuel efficiency.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, laser beam sensor system 130 can comprise a lidar system that operates to emit laser beam 132 from port 134 of commercial airplane 100. Laser beam 132 can have different wavelengths. For example, laser beam 132 can use an infrared wavelength of about 1550 nm or typically use an ultraviolet wavelength of about 350 nm.

As depicted, laser beam 132 is emitted in forward direction 135 relative to commercial airplane 100. This forward direction is relative to the direction of travel of commercial airplane 100 during flight.

In this depicted example, laser beam sensor system 130 receives backscatter light 136 generated in response to emitting laser beam 132. As depicted, laser beam 132 is emitted into atmosphere 133 into clear air turbulence 131. Backscatter light 136 is received in response to emitting laser beam 132 and is used to make measurements to detect the presence of clear air turbulence 131 ahead of commercial airplane 100.

In this illustrative example, laser beam 132 can be operated to scan area 190 ahead of commercial airplane 100. In this example, area 190 has the shape of a circle. In other examples, area 190 can have other shapes such as an ellipsoid. The dimensions of area 190 can be based on the wingspan of commercial airplane 100. For example, if the wingspan is 60 meters, the diameter of area 190 can be 60 meters.

By scanning area 190, measurements can be made to determine the intensity of clear air turbulence 131 ahead of commercial airplane 100. In this illustrative example, the scanning of area 190 can be performed by using a path that is contiguous. The path can be a spiral path beginning at central location 191 with spirals that extend to perimeter 192 of area 190.

Thus, laser beam sensor system 130 can operate to provide real time measurements of atmosphere 133 in area 190. In illustrative examples, a number of scan parameters for laser beam 132 can be adjusted during the scanning of area 190. As used herein, a “number of” when used with reference to items means one or more items. For example, a number of scan parameters is one or more scan parameters.

These adjustments to the number scan parameters can be made during the scanning of area 190. The adjustments may be during different portions of the path that laser beam 132 follows in scanning area 190. These adjustments can be made to increase at least one of speed or accuracy of these real time measurements in scanning area 190.

These measurements can include at least one of velocity, pressure, and other properties of the air in atmosphere 133. These measurements can be used to identify the presence of clear air turbulence 131.

These measurements can be used to adjust the flight of commercial airplane 100 to reduce the effects of clear air turbulence 131 in atmosphere 133 as compared to current techniques. Current techniques can forecast predictions of weather conditions that may result in clear air turbulence. However, these techniques are predictions and not actual measurements. As a result, these techniques do not enable the pilot of commercial airplane 100 to make adjustments to reduce the effects of turbulence that may be directly ahead of the path of the commercial airplane 100.

In another illustrative example, laser beam sensor system 130 can also use the backscatter data to measure a number of environmental parameters that affect the performance of the engine for commercial airplane 100. The measurement of these parameters can be used by the pilots or a flight management system to manage commercial airplane 100 to make the adjustments that increase fuel efficiency.

This number of environmental parameters can include at least one of temperature, pressure, density, humidity, or other environmental parameters for the atmosphere that can affect the performance of engines for commercial airplane 100. With these measurements, the pilot or a flight management system can determine a change or adjustment to one or more flight control settings for commercial airplane 100. The settings can be selected to increase the engine performance of the engines for commercial airplane 100. Engine performance can be increased to reduce fuel usage for commercial airplane 100.

The generation of these measurements from the backscatter data can be made much faster as compared to a pilot or other person performing an analysis to make the predictions such as those made by laser beam sensor system 130. A human operator cannot practically perform these operations quickly enough in real time to control the flight of commercial airplane 100 to obtain desired performance of commercial airplane 100.

FIG. 1 is intended as an example and not as an architectural limitation for the different illustrative examples. For example, laser beam 132 can be embedded from other locations other than port 134 in body 106. In another illustrative example, laser beam 132 can be emitted from a port located in wing 104, horizontal stabilizer 114, vertical stabilizer 118, or other suitable locations.

In another illustrative example, laser beam 132 may encounter one or more objects in area 190 during scanning of area 190. In this example, backscatter light 136 can be used to generate backscatter data for measurements that determine the presence of these objects. These objects can be, for example, a flock of birds, insects, or other objects. In other illustrative examples, these objects can also be ice or hail.

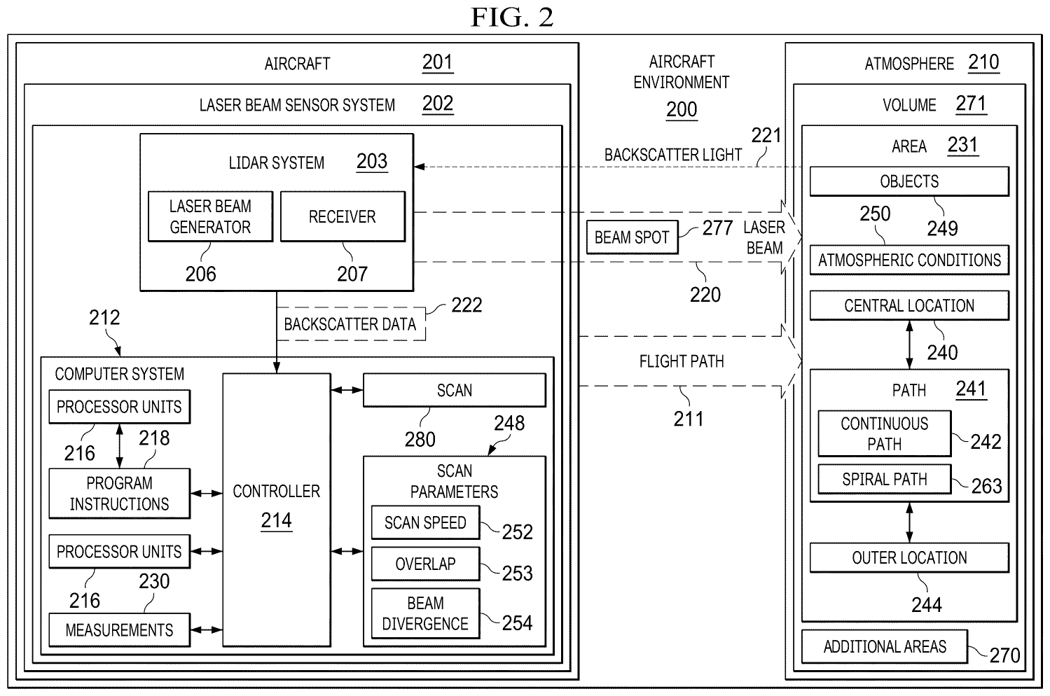

With reference now to FIG. 2, an illustration of a block diagram of a measurement environment is depicted in accordance with an illustrative embodiment. In this illustrative example, aircraft environment 200 includes components that can be implemented in hardware in an aircraft such as commercial airplane 100 in FIG. 1.

In this illustrative example, laser beam sensor system 202 operates to generate measurements of atmosphere 210. In this example, laser beam sensor system 202 is located in aircraft 201.

Aircraft 201 can take a number of different forms. For example, aircraft 201 can be selected from a group comprising a commercial aircraft, a cargo airplane, a rotorcraft, a fixed wing aircraft, a tilt-rotor aircraft, a tilt wing aircraft, a vertical takeoff and landing aircraft, an electrical vertical takeoff and landing vehicle, a glider, a personal air vehicle, an artificial intelligence controlled air vehicle, and other types of aircraft that can fly in atmosphere 210.

As depicted, laser beam sensor system 202 comprises lidar system 203, computer system 212, and controller 214. Controller 214 is located in computer system 212. These components are located within aircraft 201 in this illustrative example. In this example, lidar system 203 is also referred to as a light detection and ranging (lidar) system.

Lidar system 203 is a hardware system and can include software. In this example, lidar system 203 includes laser beam generator 206 and receiver 207. Lidar system 203 can take a number of different forms. For example, lidar system 203 can be selected from a group comprising a coherent lidar system, a direct detection lidar system, a rotational Raman lidar system, and other suitable types of lidar systems.

Lidar system 203 emits laser beam 220 into atmosphere 210 during flight of aircraft 201. In this illustrative example, laser beam 220 is emitted in a direction that is at least one of ahead of aircraft 201 or to a side of aircraft 201 using laser beam generator 206. In other illustrative examples, laser beam 220 can be emitted in other directions from laser beam generator 206. Laser beam generator 206 is a hardware component that is configured to emit laser beam 220 into atmosphere 210.

In this example, the direction ahead of aircraft 201 is a direction in which aircraft 201 is traveling. Laser beam generator 206 controls characteristics of laser beam 220. These characteristics can include at least one of a wavelength, power, timing, or other characteristics. Further, laser beam 220 can be selected from a group comprising a continuous laser beam and a pulsed laser beam. Laser beam 220 can also be a type wherein the laser beam is selected from a group comprising a CO2 laser beam, an infrared laser beam, a visible light laser beam, and other suitable types of laser beams. Further, laser beam 220 can be linearly polarized.

As depicted, one characteristic of laser beam 220 is beam spot 277. In this example, beam spot 277 is a diameter of laser beam 220 at a location in area 231. In this example, beam spot 277 can move to locations in area 231. Beam spot 277 can have a size and shape that covers location in area 231 when laser beam 220 is directed at the center of the location.

In this example, lidar system 203 is configured to receive backscatter light 221 generated in response to emitting laser beam 220. In this example, backscatter light 221 is received by receiver 207 in lidar system 203. Receiver 207 is also a hardware component and includes sensors and at least one of electronics or computers.

Lidar system 203 generates backscatter data 222 using backscatter light 221. Backscatter data 222 can include at least one of a back scatter intensity, a time of flight, or a doppler shift.

This generation of backscatter data 222 is formed by receiver 207 in lidar system 203. Backscatter data 222 is sent to controller 214 for processing. Controller 214 processes backscatter data 222 to generate measurements 230.

Controller 214 can be implemented in software, hardware, firmware, or a combination thereof. When software is used, the operations performed by controller 214 can be implemented in program instructions configured to run on hardware, such as a processor unit. When firmware is used, the operations performed by controller 214 can be implemented in program instructions and data can be stored in persistent memory to run on a processor unit. When hardware is employed, the hardware can include circuits that operate to perform the operations in controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operates a computer. When the number of processor units 216 executes program instructions 218 for a process, the number of processor units 216 can be one or more processor units that are in the same computer or in different computers. In other words, the process can be distributed between the number of processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller 214 controls lidar system 203 to move laser beam 220 to scan area 231 using path 241 from central location 240 to outer location 244 of area 231. This movement of laser beam 220 occurs as part of controller 214 controlling lidar system 203 to perform scan 280 of area 231 with laser beam 220.

The location of beam spot 277 changes during scan 280 as lidar system 203 moves laser beam 220 along path 241 over time to perform scan 280 of area 231. In this example, area 231 is an area that is to be scanned using laser beam 220.

In this example, central location 240 is the location of beam spot 277 at the beginning of path 241 and outer location 244 is the location of beam spot 277 at the end of path 241 for scan 280. In this example, central location 240 center of beam spot 277 when beam spot 277 is pointed at central location 240.

Central location 240 is the center of area 231 in this example. Outer location 244 in search area 204 is the last location in path 241 and is along the perimeter of area 231. Path 241 can be selected such that beam spot 277 covers are 231 when scan 280 is perform by moving laser beam 220 on path 241.

In this example, beam spot 277 for laser beam 220 moves over time along path 241 within area 231. Beam spot 277 is an area covered by laser beam 220. In this example, beam spot 277 is circular and has a size that can be adjusted. By moving laser beam 220 from location to location, beam spot 277 moves from location to location in search area 204 along path 241.

In this illustrative example, path 241 can take a number of different forms. For example, path 241 can be selected from at least one of continuous path 242 or spiral path 263.

Further in this example, controller 214 controls the lidar system 203 to adjust a number of scan parameters 248 during movement of laser beam 220 on path 241. The number of scan parameters 248 can be selected from at least one of scan speed 252, or overlap 253 between spirals in a spiral path, scan speed, beam divergence 254, or other suitable scan parameter.

In this illustrative example, the number of scan parameters 248 can be adjusted to increase the speed or accuracy of making measurements 230 generated from backscatter data 222.

In this depicted example, controller 214 generates measurements 230 of area 231 using backscatter data 222 generated from backscatter light 221 resulting from scanning area 231. In this example, measurements 230 can be made for detecting at least one of atmospheric conditions 250 or objects 249.

Atmospheric conditions 250 can take a number of different forms. For example, atmospheric conditions 250 can be selected from at least one of an air density, a temperature, a speed of air, turbulence, or other conditions. Objects 249 can be selected from at least one of insects, birds, bats, water droplets, or other objects that may be within area 231 in atmosphere 210.

In one illustrative example, measurements 230 are generated to detect an atmospheric condition such as clear air turbulence. Detecting clear air turbulence quickly is important in operating aircraft 201. It is desirable to detect clear air turbulence with sufficient time to perform actions that may avoid or mitigate the effects of the clear air turbulence. As a result, minimizing the time needed to scan area 231 is an objective in making the adjustments to the number of scan parameters 248.

In this example, the amount of time to scan area 231 can be fixed to obtain a desired level of performance in detecting clear air turbulence. This desired level of performance can be an ability to detect air turbulence before aircraft 201 encounters the air turbulence. Further, it is desirable to detect clear air turbulence with a sufficient amount of time to enable one or more actions to be taken by aircraft 201 to mitigate or avoid the effects of clear air turbulence detected in area 231. For example, an action can be to change flight path 211 to avoid the clear air turbulence, change the configuration flight control surfaces of aircraft 201 to reduce the effects of clear air turbulence, or other actions.

When aircraft 201 uses lidar system 203 to scan atmosphere 210 ahead of aircraft 201 for clear air turbulence, the clear air turbulence closest to flight path 247 of aircraft 201 is more likely to disrupt the motion of aircraft 201. For example, clear air turbulence at central location 240 may have a greater effect as compared to clear air turbulence at outer location 244 in area 231.

With this clear air turbulence example, laser beam 220 begins scanning area 231 at selected distance in front of aircraft 201. Laser beam 220 is directed to begin scan 280 at central location 240 of area 231. Flight path 247 for aircraft 201 extends through central location 240.

Further in this example, scan 280 moves on path 241 in the form of spiral path 263 from central location 240 in a spiral pattern until laser beam 220 reaches the end of scan 280 at outer location 244. Outer location 244 is the farthest from the flight path of aircraft 201.

If clear air turbulence exists in a particular location in area 231, the probability of detecting clear air turbulence at that particular location can be increased by adjusting a number of scan parameters 248 during the movement of laser beam 220 on spiral path 263 to perform scan 280 of area 231. The adjustments to the number of scan parameters 248 can be selected from at least one of increasing beam divergence 254 or increasing overlap 253. These changes to the number of scan parameters 248 can increase the probability of detecting clear air turbulence in measurements 230 made using backscatter data 222.

Increasing beam divergence 254 at a particular location can decrease the laser beam power at that particular location. Decreasing beam divergence 254 at a location can increase the laser beam power at that location. Increase beam power may provide a greater accuracy in making measurements 230 to detect clear air turbulence. Lowering beam divergence 254 can increase the number of spirals in a spiral path for scan 280, which results in a greater scan time to perform scan 280 of area 231.

Scan speed 252 sets the speed at which laser beam 220 moves along spiral path 263. Decreasing scan speed 252 can increase the amount of time laser beam 220 is present at that particular location. As scan speed 252 increases, the amount of time needed to perform scan 280 increases.

Increasing overlap 253 results in a greater number of spirals being present in spiral path 263. Increasing the number of spirals results in a greater scan time to scan area 231.

In this example, controller 214 operates to detect clear air turbulence closest to flight path 211. In performing scan 280, scan time is limited in these examples. The amount of scan time selected for scan 280 can be based on service level agreements (SLAs), regulations, standards, or other factors setting or limiting the scan time when detecting clear air turbulence.

Making adjustments to the number of scan parameters 248 to increase the ability to make measurements 230 to detect turbulence can result in increasing the scan time for scan 280 beyond what is desired or allowable.

To reduce the amount of scan time, the number of scan parameters 248 can be adjusted based on portions of spiral path 263 that have greater importance in making measurements 230. As a result, increases in scan time resulting from by adjustments in the number of scan parameters 248 that increase the ability to make measurements 230 can be offset by decreases in the amount of scan time resulting from other adjustments to the number of scan parameters 248.

In this depicted example, the importance of particular portions of spiral path 263 is the location of those portions relative to central location 240, which is the location through which flight path 211 extends. Portions closer to central location 240 are more important as compared to portions farther away from central location 240. The adjustments can be made such that scan parameters 248 such as scan speed 252 is lowest, beam divergence 254 is greatest, and overlap 253 is greatest along portions of spiral path 263 that are closest to central location 240.

For example, in scan 280, the laser beam power decreases by increasing beam divergence 254. In this manner, the scan time can be reduced for later portions of spiral path 263 using a lower beam divergence. Beam divergence 254 can be lowest at central location 240 resulting in the highest power at central location 240. In this example, central location 240 has the highest importance with respect to detecting air turbulence along flight path 211 because flight path 211 of aircraft 201 passes through central location 240. In this example, outer location 244 has a lower level of importance because this location is farther away from flight path 211.

With respect to scan speed 252, the slowest scan speed is at central location 240. Scan speed 252 increases as scan 280 progresses. Thus, scan speed 252 is slowest at central location 240 and is fastest at outer location 244.

Further in this example, detecting air turbulence at the central location 240 is more important as compared to outer location 244 and scan time is limited. With these factors in mind, overlap 253 between adjacent sections of the spiral path decrease as scan 280 progresses. In this example, overlap 253 has the greatest overlap at central location 240 and the least overlap at outer location 244.

These adjustments to the number of scan parameters 248 can be made during the performance of scan 280 such that the scan time does not increase or exceed a selected amount of time set for scanning area 231 to detect clear air turbulence.

In one illustrative example, controller 214 moves laser beam 220 to scan a number of additional areas 270 at different distances from aircraft 201. In this example, controller 214 generates measurements 230 for volume 271 formed by area 231 in the number of additional areas 270. Each of these additional areas can be scanned using a path from the central location to another location as described for area 231.

In one illustrative example, one or more solutions are present that overcome a problem with make measurements as quickly as possible to have sufficiency time to perform actions based on the measurements. Increasing speed at which measurements can be made provides a pilot or a control system more time to make changes to the operation of an aircraft.

These changes can be made to avoid or reduce the effects of environmental conditions such as turbulence or windshear. Additionally, changes can be made based on measurements such as temperature and pressure to increase the fuel efficiency of an aircraft. These changes can also be made to avoid or reduce hazards that may be cause by objects.

In this example, controller 214 transforms computer system 212 into a special purpose computer system as compared to currently available general computer systems that do not have controller 214. In the illustrative example, the use of controller 214 in computer system 212 integrates processes into a practical application for the laser beam to scan an area using a path from the central location to an outer location and adjusting scan parameters during scanning of the area using the path. Measurements can be generated based on the backscatter data created from backscatter light detected in response to laser beam 220.

In these examples, controller 214 in computer system 212 is directed to a practical application of processes integrated into controller 214 in computer system 212 that enables making measurements more quickly such that these measurements can be used to manage the operation of aircraft 201.

The illustration of aircraft environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, aircraft 201 can include one or more lidar systems controlled by controller 214. Controller 214 can control these additional lidar systems to scan area 231 or other areas in atmosphere 210 to generate backscatter data for analysis in making measurements 230.

In another example, these different lidar systems scan a number of additional areas 272 at different distances from aircraft 201. The laser beams from these additional lidar systems can use paths that have the same shape as path 241 of different shapes. For example, these additional areas can be scanned using paths in the form of spiral paths in which a number of scan parameters 248 may be adjusted differently from the number of scan parameters 248 in path 241.

In other examples, lidar system 203 can emit one or more laser beams in addition laser beam 220 to scan the other areas.

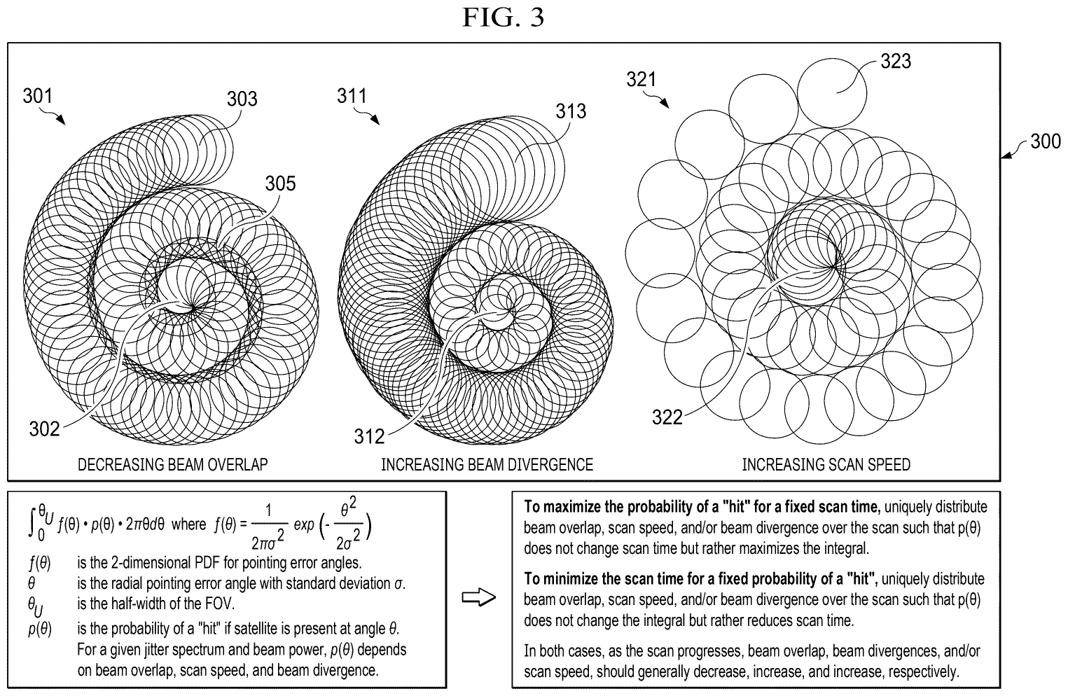

With reference next to FIG. 3, an illustration of a continuous spiral scan system is depicted in accordance with an illustrative environment. In this illustrative example, spiral scans 300 are continuous spiral scans that have continuous paths. In this example, the different spiral scans depicted have scan parameters. The scan parameters are examples of the number of scan parameters 248 in FIG. 2.

For example, spiral scan 301 is an example of decreasing beam overlap. As depicted, spiral scan 301 is comprised of locations for a beam spot in which each location is the location of the beam spot as the beam spot moves along a spiral path over time. The beam spot is represented by the circles for the locations and the beam spot moves in performing spiral scan 301. The center of each circle is the location at which the laser beam is pointed in this example.

The laser beam is pointed at a location. The diameter of each beam spot is dependent on the beam divergence and how far the beam has propagated. In spiral scan 301 the divergence is fixed. Divergence is the angle at which a laser beam spreads as the laser beam propagates.

With this example, the beam spot size is dependent on the distance of the location from the laser source. For example, a laser beam directed at an object or atmospheric condition at a location that is a first distance away from a laser source will have a first beam spot size. The laser beam directed at an object or atmospheric condition at a second location that is a second distance from the laser source will have a larger diameter if that second distance is greater than the first distance.

In this illustrative example, the beam spot for spiral scan 301 has the same diameter because the beam spot moves in a spiral path in an area where all of the locations are the same distance away from the laser beam source.

These locations are represented by circles. These locations are in a search area for spiral scan 301.

In this example, spiral scan 301 starts from central location 302 and moves from location to location on the spiral path to outer location 303. The direction of motion is in the direction from central location 302 to outer location 303. These locations from central location 302 to outer location 303 illustrate the spiral path for spiral scan 301. In this example, central location 302 is the innermost circle and outer location 303 is the outermost circle in spiral scan 301.

In this example, overlap 305 is present between the locations in spiral scan 301. Overlap 305 is the overlap between locations in adjacent portions of the spiral path for the locations from central location 302 to outer location 303.

For example, an overlap between two locations in spiral scan 301 can be the overlap between a first location on the spiral path and a second location that is perpendicular to the direction of motion of the laser beam on the spiral path.

In this example, the amount of overlap 305 decreases as the beam spot moves from central location 322 to outer location 323 along the spiral path. The amount of overlap 305 is greatest at central location 322 and the amount of overlap 305 is the least at outer location 323.

Next, spiral scan 311 is an example of increasing beam divergence. In this example, spiral scan 311 is comprised of locations for a beam spot in which each location is the location of the beam spot as the beam spot moves along a spiral path with a direction of motion starting at central location 312 and ending at outer location 313.

This scan shows an increasing divergence as the scan progresses from central location 312 to outer location 313. In this example, divergence of a laser beam can be from the laser beam source by changing the optical configuration of the laser beam source. This change in optical configuration can change the angle at which the laser beam diverges.

The divergence is the size of the beam spot in this example. The size of the beam spot is the size of the circles representing the locations for the beam spot in spiral scan 311. For example, central location 312 has a smaller divergence as compared to outer location 313.

Spiral scan 321 is an example of increasing scan speed. As depicted, spiral scan 321 is comprised of locations for a beam spot in which each location is the location of the beam spot as the beam spot moves along a spiral path with a direction of motion starting at central location 322 and ending at outer location 323. These locations are represented by circles with central location 302 being the innermost circle and outer location 303 being the outermost circle in spiral scan 301.

In this example, the speed of spiral scan 321 increases as the beam spot moves along a spiral path from central location 322 to outer location 323. The increasing speed is depicted by the distance between locations along the spiral path. As depicted, the distance between locations along the spiral path increases indicating an increase in scan speed.

With spiral scans 300, parameters such as overlap, divergence, and scan speed can be changed when a continuous scan is being performed as depicted in this figure.

The total overlap can be distributed to provide greater amounts of overlap in some parts of the path as compared to other parts of the path with the total overlap being the same as the path in which the amount of overlap does not change.

For example, the error in two-dimensional probability density function for pointing error angles is as follows:

$${\int }_{0}^{{θ}_{U}} f ( θ ) \cdot p ( θ ) \cdot 2 πθ d θ where f ( θ ) = \frac{1}{2 π {σ}^{2}} exp ( - \frac{{θ}^{2}}{2 {σ}^{2}} )$$

where θ_{U} is the half-width of the field of view (FOV) and p(θ) is the probability of a “hit” if a satellite is present at angle θ. For a given jitter spectrum and beam power, p(θ) depends on beam overlap, scan speed, and beam divergence.

To maximize the probability of a “hit” for a fixed scan time, a number of scan parameters can be selected to at least one of uniquely distribute beam overlap, scan speed, or beam divergence over the scan such that p(θ) does not change scan time but rather maximizes the integral.

To minimize the scan time for a fixed probability of a “hit”, a number of scan parameters can be selected to at least one of uniquely distribute beam overlap, scan speed, and/or beam divergence over the scan such that p(θ) does not change the integral but rather reduces scan time.

In both cases, as the scan progresses, scan parameters such as at least one of beam overlap, scan speed, or beam divergence can be selected to at least one of decrease or increase.

The illustration of spiral scans 300 in FIG. 3 is presented as an example of one manner in which spiral scans can be implemented. This example is not meant to limit the manner in which other spiral scans can be implemented and what scan parameters can be changed in other examples. Further, although a single parameter such as overlap in spiral scan 301, divergence in spiral scan 311, scan speed in spiral scan 321 is changed, multiple scan parameters can change during the movement of the laser beam in other examples.

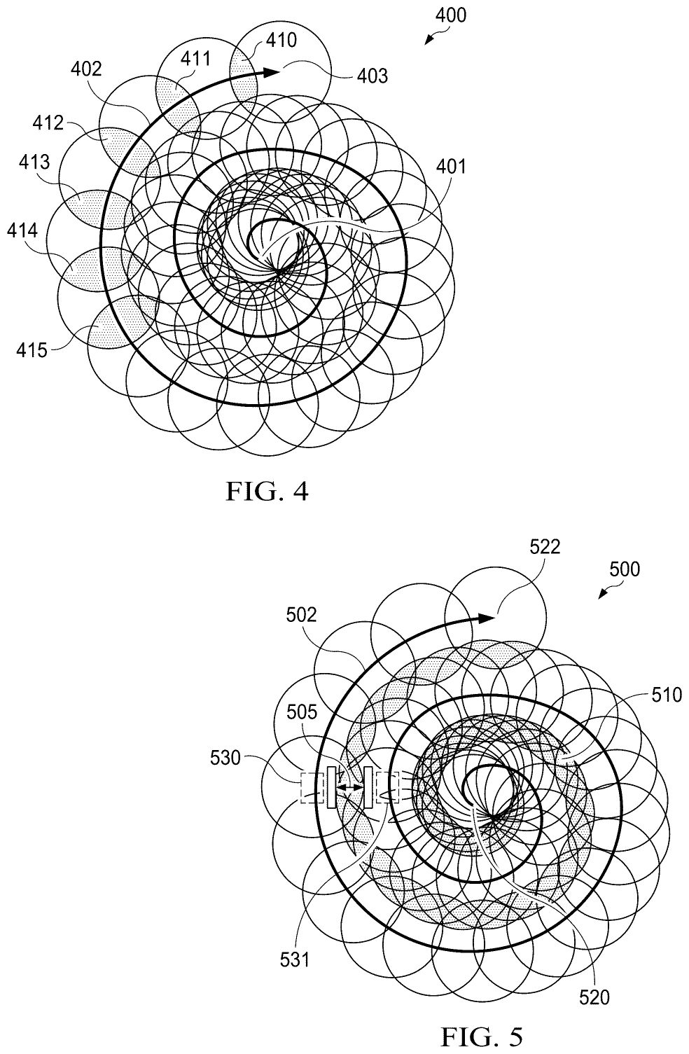

Turning next to FIG. 4, an illustration of scan speed for a spiral scan is depicted in accordance with an illustrative embodiment. In this example, spiral scan 400 is depicted in which each circle represents a location for a beam spot at a particular point in time. In this example, path 402 represents a path with a direction of motion of the beam spot on a plane in space as the beam spot moves on path 402 in spiral scan 400 from central location 401 to outer location 403.

In this example, overlap is present between locations in the direction of path 402. In this example, instances in time are equally spaced, and the overlap between two adjacent circles indicates the scan speed as shown by the regions. For example, region 410, region 411, region 412, region 413, region 414, and region 415 are examples of regions of overlap that can be used to indicate the scan speed.

In these examples, the greater amount of overlap results in a larger region that indicates a slower scan speed than a lesser amount of overlap with a smaller region. For example, the beam is scanning faster in spiral scan 400 at the portion of the scan with region 410 as compared to the portion of the scan with region 415. This overlap can also be referred to as motion overlap which can illustrate scan speed as a function of location in spiral scan 400.

In FIG. 5, an illustration of an overlap is depicted in accordance with an illustrative embodiment. In this illustrative example, spiral scan 500 comprises circles that represent a location for a beam spot at a particular point in time. In this example, path 502 represents the direction of motion of the beam spot on a path with a direction of motion on a plane in space as the beam spot moves on path 502 for spiral scan 500.

As depicted, overlap 510 is present between the adjacent portions of path 502 in spiral scan 500. In this example, the scan begins at central location 520 and ends at outer location 522.

In this illustrative example, the overlap of beam spot locations between two adjacent portions of path 502 is an overlap between the locations in the adjacent portions of path 502. For example, portion 530 of path 502 is adjacent to portion 531 of path 502.

In this example, the overlap is between a first location and a second location that is perpendicular to the direction of motion. In this example, overlap 510 has width 505. This width is constant along path 502 in this example but can be changed for different portions of path 502 in other examples such that the overlap between locations of the beam spot changes during movement of the beam spot on path 502. This overlap can be referred to as a path overlap and can be used to increase the probability of detecting an object such as a satellite while minimizing the time to scan a search area. In these examples, the probability of detecting the satellite is dependent in part on overlap 510 of adjacent portions of path 502.

The illustration of motion overlap in FIG. 4 and path overlap in FIG. 5 are provided as examples and not meant to limit the manner in which other illustrative examples can be implemented. For example, other scans can have other lengths. Further, in other scans, divergence can be different for different portions of the path.

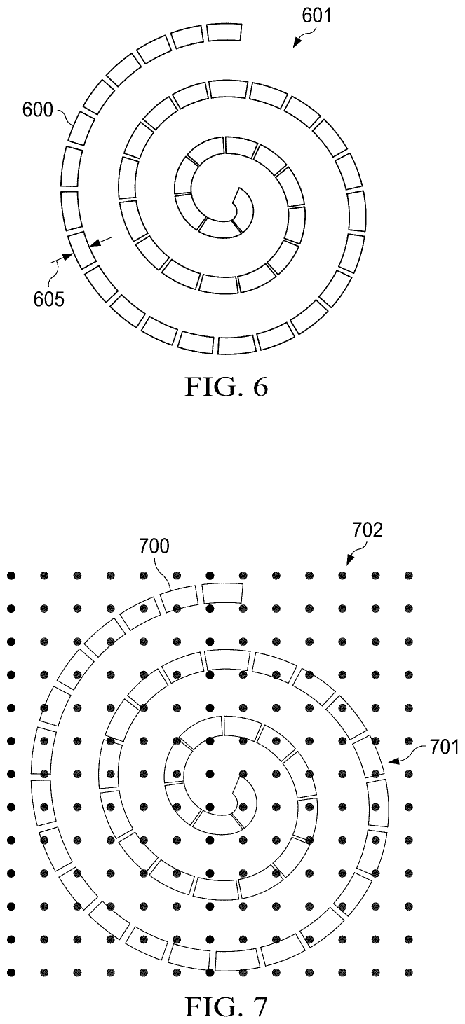

With reference to FIG. 6, an illustration of an overlap for a spiral scan is depicted in accordance with an illustrative embodiment. As depicted, overlap 600 represents the area where locations for a spot overlap as the laser beam is moved along a spiral path. In this example, overlap 600 is shown as being the same throughout a spiral scan. In this example, overlap 600 is divided into segments 601. In this example, the segments each have the same length. These segments are shown as having the same thickness, meaning that each segment has the same amount of overlap. In this example, overlap 600 has width 605.

In this illustrative example, the overlap can be selected to increase the ability to detect a jumper. In this example, a jumper is an object or atmospheric condition that is missed by a laser beam that is pointed to a location in which the object or atmospheric condition is located. The laser beam can miss the object because of beam vibrations. These beam vibrations can be caused by jitter. From the laser beam's frame of reference, the object or atmospheric condition appears to “jump” outside of the beam spot.

The overlap where the spot of the laser beam on the current portion of a path overlaps a prior portion of the path or overlaps a future portion of the path can increase the ability to detect a jumper.

The amount of overlap in different segments of the path can be selected such that the time needed to scan the entire path is the same as if the spiral path used the same amount of overlap for the entire path. In other words, different segments can have different amounts of overlap such that the total overlap present along the spiral path for the segments can be the same as the total overlap for a path in which the amount of overlap is the same along the spiral path.

Turning next to FIG. 7, an illustration of an overlap based on jumper distribution is depicted in accordance with an illustrative embodiment. In this illustrative example, overlap 700 is comprised of segments 701. Jumpers 702 are shown as dots.

A jumper can cause the laser beam to miss the intended location for generating backscatter light to make a measurement at the location. In other words, that measurement can be clear air turbulence. The location to which the jumper causes backscatter light may have an absence of clear air turbulence. As a result, jumpers can reduce the accuracy of measurements when scanning an area. A similar issue can occur if the scanning is being performed to identify objects such as insects in the area.

If most jumpers are located at the center of an area, the amount of overlap can be greater in those areas as compared to other areas. As a result, greater overlap is present for segments closer to the center with segments father away from the center having less overlap.

In this example, a uniform distribution of jumpers 702 are shown in this figure. With this distribution, segments 701 in overlap 700 can all have the same amount of overlap because the segments can detect jumpers 702 equally because of the uniform distribution based on the likelihood that the object or atmospheric condition of interest is at center 812.

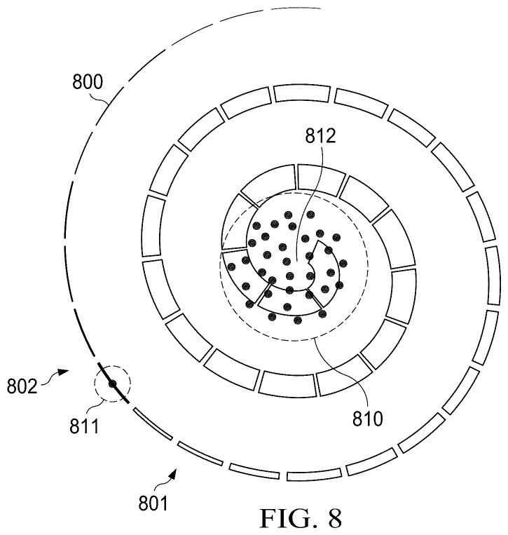

Next in FIG. 8, an illustration of an overlap based on a jumper distribution is depicted in accordance with an illustrative embodiment. In this example, overlap 800 is comprised of segments 801. In this example, jumpers 802 are present. With this example, most of jumpers 802 are located in region 810 with a single jumper being located in region 811.

With most of jumpers 802 located in center 812 of the spiral, the segments located near center 812 detect more jumpers. Thus, these segments have a high value. Likewise, only a single jumper is located in region 811. The segments located near the edge detect very few jumpers. These segments have a low value.

In this example, the object or atmospheric condition of interest has the highest probability of being at or near center 812. In other examples, the flight path passes through center 812.

As a result, the importance of making measurements to detect an object or an atmospheric condition are more important at center 812 than at the end of the scan. The measurements may have a curve with a Gaussian shape. For example, the breadth of the Gaussian shape can be a standard deviation (STD) determined by the distance of the area being scanned in front of the aircraft. For example, the standard deviation at 30 meters is smaller than the standard deviation at 10 kilometers. Further, a cross wind can shift the center of the Gaussian curve towards the direction from which the wind originates.

The illustration of overlaps in FIGS. 6-8 have been provided as examples and are not meant to limit the manner in which other illustrative examples can be implemented. For example, segments can increase in overlap at least in portions of the path as compared to other portions. The selection of which segments have greater overlap can be based on the probability that jumpers are located in different portions of the path for the spiral scan.

Further, the illustrative examples depicted in FIGS. 3-8 can be applied to other types of electromagnetic beams in addition to or in place of laser beams. For example, these different examples can also be applied to a radio frequency beam, a microwave beam, or other electromagnetic beams.

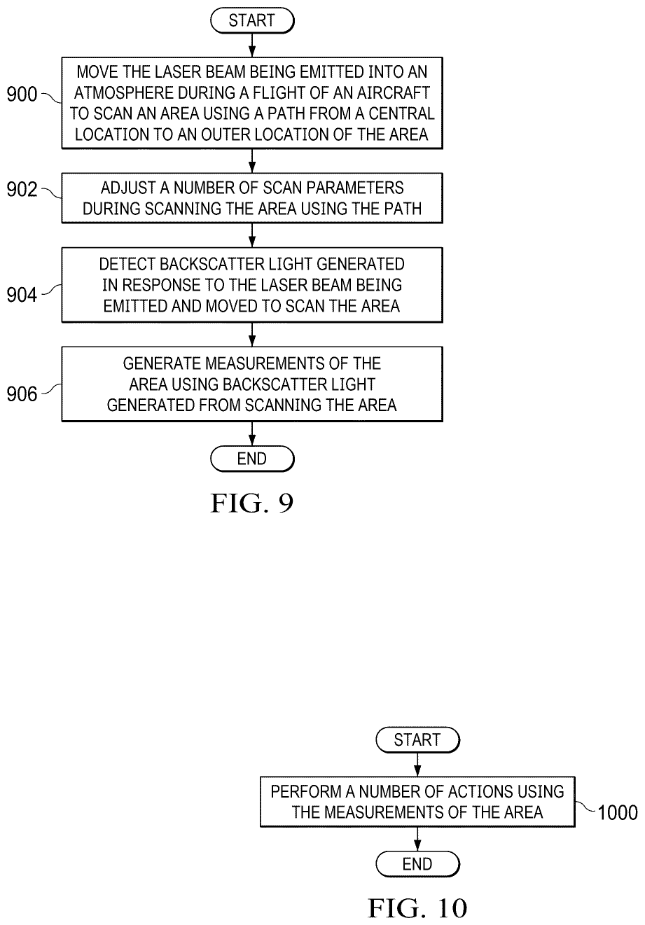

With reference to FIG. 9, an illustration of a flowchart of a process for making measurements with a laser beam is depicted in accordance with an illustrative embodiment. The process in FIG. 9 can be implemented in hardware, software, or both. When implemented in software, the process can take the form of program instructions that are run by one or more processor units located in one or more hardware devices in one or more computer systems. This process can be implemented to identify locations for pointing a laser beam emitted from a laser beam system. For example, the process can be implemented in controller 214 in computer system 212 in FIG. 2. In this example, a laser beam is emitted in a direction that is at least one of ahead of the aircraft or to a side of the aircraft.

The process begins by moving the laser beam being emitted into an atmosphere during a flight of an aircraft to scan an area using a path from a central location to an outer location of the area (operation 900). In operation 900, the path can be selected from at least one of a continuous path or a spiral path.

The process adjusts a number of scan parameters during scanning the area using the path (operation 902). The process detects backscatter light generated in response to the laser beam being emitted and moved to scan the area (operation 904).

The process generates measurements of the area using backscatter light generated from scanning the area (operation 906). The process terminates thereafter. In operation 906, the backscatter light is used to generate the measurements from backscatter data generated from detecting the backscatter light.

In operation 906, the measurements are for at least one of atmospheric conditions or objects. The atmospheric conditions can be selected from at least one of air density, temperature, speed of air, turbulence, or other suitable atmospheric conditions. The objects can be selected from at least one of insects, birds, bats, water droplets, or other suitable objects for detection.

Next in FIG. 10, an illustration of a flowchart of a process for performing actions using the measurements is depicted in accordance with an illustrative embodiment. The process in FIG. 10 is an example of additional operations that can be performed with the operations in FIG. 9.

The process performs a number of actions using the measurements of the area (operation 1000). The process terminates thereafter. In operation 1000, the measurements can be for at least one of atmospheric conditions or objects. For example, with the detection of clear air turbulence, control surfaces can be adjusted to counteract turbulence encountered by the aircraft. As another example, aircraft can change a flight path to avoid objects such as a flock of birds that may be detected in the area ahead of the aircraft. These and other actions can be performed based on the measurements made for different atmospheric conditions and objects.

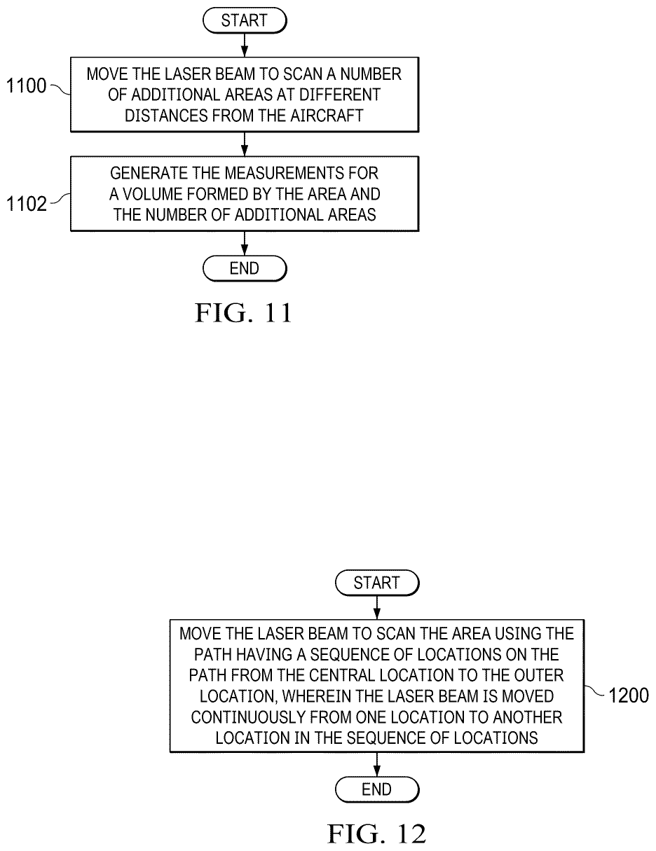

Turning next to FIG. 11, an illustration a flowchart of a process for making measurements for a volume is depicted in accordance with an illustrative embodiment. The operations in this flowchart are additional operations that can be performed by the operations in FIG. 9. In this illustrative example, the volume can be a volume of the atmosphere.

The process moves the laser beam to scan a number of additional areas at different distances from the aircraft (operation 1100). The process generates the measurements for a volume formed by the area and the number of additional areas (operation 1102). The process terminates thereafter.

With reference now to FIG. 12, an illustration of a flowchart of a process for moving a laser beam is depicted in accordance with an illustrative embodiment. The process in this flowchart is an example of an implementation for operation 900 in FIG. 9.

The process moves the laser beam to scan the area using the path having a sequence of locations on the path from the central location to the outer location, wherein the laser beam is moved continuously from one location to another location in the sequence of locations (operation 1200). The process terminates thereafter.

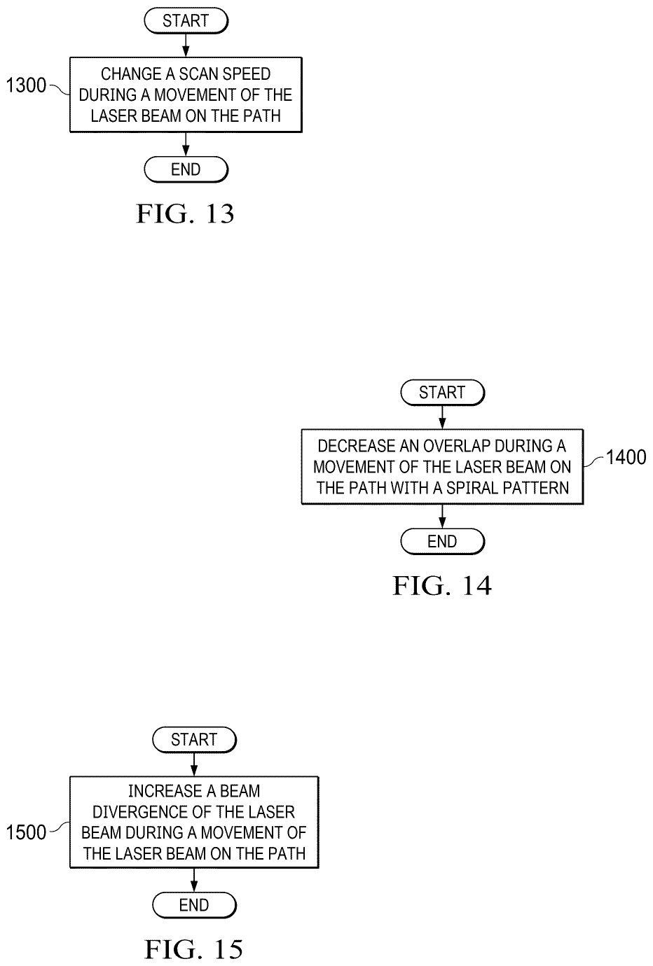

In FIG. 13, an illustration of a flowchart of a process for adjusting a number of scan parameters is depicted in accordance with an illustrative embodiment. The process in this flowchart is an example of an implementation for operation 902 in FIG. 9. This process can be performed when the laser beam is moved with a continuous movement.

The process changes a scan speed during a movement of the laser beam on the path (operation 1300). The process terminates thereafter. In this illustrative example, the scan speed can be changed by at least one of increasing or decreasing the scan speed.

With reference to FIG. 14, an illustration of a flowchart of a process for adjusting a number of scan parameters is depicted in accordance with an illustrative embodiment. The process in this flowchart is an example of an implementation for operation 902 in FIG. 9. This process can be performed when the laser beam is moved with a continuous movement. In this example, the path is a spiral path.

The process decreases an overlap during a movement of the laser beam on the path with a spiral pattern (operation 1400). The process terminates thereafter.

Next in FIG. 15, an illustration of a flowchart of a process for adjusting a number of scan parameters is depicted in accordance with an illustrative embodiment. The process in this flowchart is an example of an implementation for operation 902 in FIG. 9. This process can be performed when the laser beam is moved with a continuous movement.

The process increases a beam divergence of the laser beam during a movement of the laser beam on the path (operation 1500). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

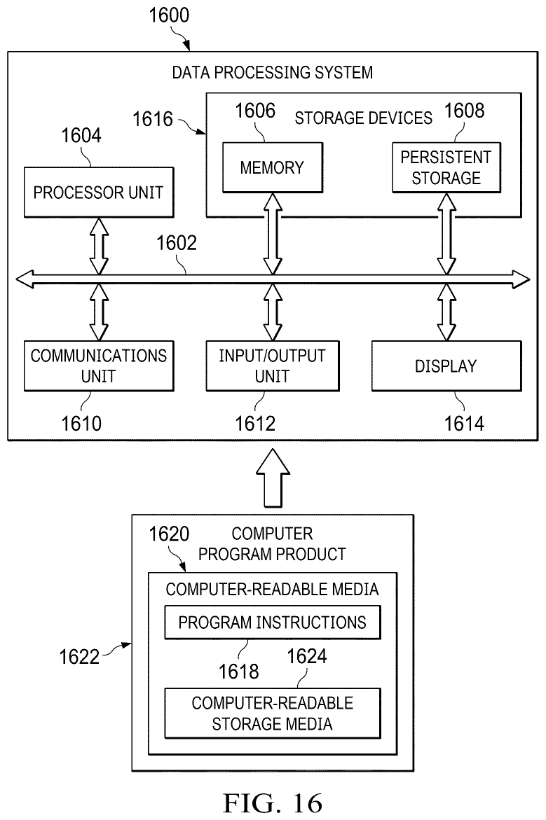

Turning now to FIG. 16, an illustration of a block diagram of a data processing system is depicted in accordance with an illustrative embodiment. Data processing system 1600 can be used to implement computer system 212 in FIG. 2.

In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 are located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer-readable storage media 1624 is a physical or tangible storage device used to store program instructions 1618 rather than a medium that propagates or transmits program instructions 1618. Computer-readable storage media 1624 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1624, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A laser beam sensor system comprising:
a lidar system in an aircraft, wherein the lidar system is configured to:
emit a laser beam into an atmosphere during flight of the aircraft;
receive backscatter light generated in response to emitting the laser beam; and
generate backscatter data using the backscatter light; and
a controller configured to:
control the lidar system to move the laser beam to scan an area using a path from a central location to an outer location of the area;
adjust a number of scan parameters during scanning the area using the path; and
generate measurements of the area using the backscatter data generated from scanning the area.

2. The laser beam sensor system of claim 1, wherein the controller is configured to:
move the laser beam to scan a number of additional areas at different distances from the aircraft; and
generate the measurements for a volume formed by the area and the number of additional areas.

3. The laser beam sensor system of claim 1, wherein in moving the laser beam, the controller is configured to:
move the laser beam to scan the area using the path having a sequence of locations on the path from the central location to the outer location, wherein the laser beam is moved continuously from one location to another location in the sequence of locations.

4. The laser beam sensor system of claim 1, wherein the path is selected from at least one of a continuous path or a spiral path.

5. The laser beam sensor system of claim 1, wherein the laser beam is emitted in a direction that is at least one of ahead of the aircraft or to a side of the aircraft.

6. The laser beam sensor system of claim 1, wherein the measurements are for at least one of atmospheric conditions or objects.

7. The laser beam sensor system of claim 6, wherein the atmospheric conditions are selected from at least one of air density, temperature, speed of air, or turbulence.

8. The laser beam sensor system of claim 6, wherein the objects are selected from at least one of insects, birds, bats, or water droplets.

9. The laser beam sensor system of claim 1, wherein the laser beam is selected from a group comprising a continuous laser beam and a pulsed laser beam.

10. The laser beam sensor system of claim 1, wherein the laser beam is linearly polarized.

11. The laser beam sensor system of claim 1, wherein the aircraft is selected from a group comprising a commercial aircraft, a cargo airplane, a rotorcraft, a fixed wing aircraft, a tilt-rotor aircraft, a tilt wing aircraft, a vertical takeoff and landing aircraft, an electrical vertical takeoff and landing vehicle, a glider, a personal air vehicle, and an artificial intelligence controlled air vehicle.

12. The laser beam sensor system of claim 1, wherein the lidar system is selected from a group comprising a coherent lidar system, a direct detection lidar system, and a rotational Raman lidar system.

13. The laser beam sensor system of claim 1, wherein number of scan parameters is selected from at least one a scan speed, an overlap, or a beam divergence.

14. A method for making measurements with a laser beam, the method comprising:
moving the laser beam being emitted into an atmosphere during a flight of an aircraft to scan an area using a path from a central location to an outer location of the area;
adjusting a number of scan parameters during scanning the area using the path;
detecting backscatter light generated in response to the laser beam being emitted and moved to scan the area;
generating backscatter data from the backscatter light; and
generating the measurements of the area using the backscatter data generated from scanning the area.

15. The method of claim 14 further comprising
performing a number of actions using the measurements of the area.

16. The method of claim 14 further comprising:
moving the laser beam to scan a number of additional areas at different distances from the aircraft; and
generating the measurements for a volume formed by the area and the number of additional areas.

17. The method of claim 14, wherein moving the laser beam comprises:
moving the laser beam to scan the area using the path having a sequence of locations on the path from the central location to the outer location, wherein the laser beam is moved continuously from one location to another location in the sequence of locations.

18. The method of claim 14, wherein the path is selected from at least one of a continuous path or a spiral path.

19. The method of claim 14, wherein the laser beam is emitted in a direction that is at least one of ahead of the aircraft or to a side of the aircraft.

20. The method of claim 14, wherein the measurements are for at least one of atmospheric conditions or objects.

21. The method of claim 20, wherein the atmospheric conditions are selected from at least one of air density, temperature, speed of air, or turbulence.

22. The method of claim 20, wherein the objects are selected from at least one of insects, birds, bats, or water droplets.

23. The method of claim 14, wherein the laser beam is selected from a group comprising a continuous laser beam and a pulsed laser beam.

24. The method of claim 14, wherein the laser beam is linearly polarized.

25. The method of claim 14, wherein the aircraft is selected from a group comprising a commercial aircraft, a cargo airplane, a rotorcraft, a fixed wing aircraft, a tilt-rotor aircraft, a tilt wing aircraft, a vertical takeoff and landing aircraft, an electrical vertical takeoff and landing vehicle, a glider, a personal air vehicle, and an artificial intelligence controlled air vehicle.

26. The method of claim 14, wherein the laser beam is emitted from a lidar system selected from a group comprising a coherent lidar system, a direct detection lidar system, and a rotational Raman lidar system.

27. The method of claim 14, wherein number of scan parameters is selected from at least one a scan speed, an overlap, or a beam divergence.
